(19) United States
(12) Patent Application Publication
(10) Pub. No.: US 2008/0223302 A1
(43) Pub. Date: Sep. 18, 2008

(54) Animal Litter, Process for Preparing Animal Litter, and Method of Removal of Animal Waste

(75) Inventors: Lin Wang, Iowa City, IA (US); Sarjit Johal, Iowa City, IA (US); Thomas A. Wiesner, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 12/049,821

(22) Filed: Mar. 17, 2008

Related U.S. Application Data
(60) Provisional application No. 60/895,000, filed on Mar. 15, 2007.

(51) Int. Cl. A01K 29/00; B01J 20/22

(52) U.S. Cl. 119/173; 119/171; 502/401; 502/80

(57) ABSTRACT

Disclosed are an animal litter, a process for preparing the animal litter, and a method for removal of animal waste. The method for removal of animal waste comprises providing a copra residue, such as copra cake or copra oil cake, allowing an animal to excrete waste into the litter, and removing at least a portion of the soiled litter. An animal litter in accordance with the disclosed teachings includes a copra residue in combination with one or more absorbent materials, such as clay, whole ground grain, spent grain germ, or any other absorbent material. The process for preparing the animal litter comprises blending copra residue with one or more absorbent materials. The animal litters disclosed herein may include other ingredients, such as additional absorbent materials, preservatives, and so forth.

### TECHNICAL FIELD OF THE INVENTION

The present invention relates to an animal litter, and more particularly to a litter that includes a copra residue, such as copra cake. The invention further pertains to a process for preparing an animal litter, methods for removal of animal waste, and related products, processes, and methods.

### BACKGROUND OF THE INVENTION

Numerous animal litters are known in the prior art. Commonly, animal litters are based on absorbent clays. The simplest animal litters include solely absorbent clay. In other cases, additives, such as odor control agents, adhesives, and other materials are included. Because animal urine has a strong odor of ammonia, many efforts have been made to provide animal litters that absorb ammonia and that prevent ammonia odors from escaping, particularly when the litter is employed for use with household cats.

Numerous litters are disclosed in U.S. Pat. Nos. 6,868,802; 6,622,658; 6,405,677; 6,216,634; and 6,098,569, all assigned to Grain Processing Corporation of Muscatine, Iowa. These patents provide excellent teachings as to litters that include organic, biodegradable materials, and that, in preferred embodiments, are based exclusively on natural materials. The litters exemplified in these patents have excellent ammonia absorbing properties.

The present invention seeks to provide an animal litter that differs from the heretofore described litters.

### THE INVENTION

It has now been discovered that an animal litter may be composed of a copra residue, such as copra cake. Animal litters prepared in accordance with the present teachings can be formulated to have excellent ability to absorb or mask ammonia odors and other odors of animal urine. Copra residue may be used as an animal litter, and may be blended with other materials to form animal litters.

In one embodiment, the invention comprises a method for removal of animal waste. The method includes providing a litter that includes a copra residue, allowing an animal to excrete waste into a quantity of the litter, and removing at least a portion of litter that has been soiled. Removal of the litter that has been soiled may comprise separation of at least a portion of the soiled litter from litter that has not been soiled. Alternatively, removal of litter that has been soiled may comprise removal and disposal of some or all of the unsoiled litter.

In another embodiment, the invention provides an animal litter. An animal litter in accordance with the preferred embodiments of the present invention includes a copra residue in combination with one or more other ingredients, such as a clay, whole ground grain, seed meal, virgin grain germ, spent grain germ, or other absorbent material. The litter may take the form of either a clumping animal litter or a non-clumping animal litter.

In some embodiments, the litter is provided in the form of discrete plural particles, which may be compacted particles such as pellets. Litters prepared in accordance with the present teachings will be expected to have excellent odor control properties. Moreover, when used in connection solely with other biodegradable materials, a litter prepared in accordance with these teachings is biodegradable, and hence flushable into a sewer or septic system.

Also encompassed by the invention is a process for preparing an animal litter. The process includes combining the ingredients of the litter, the ingredients including copra residue and at least one other absorbent material as discussed herein. In some embodiments, the litter ingredients may be pelletized and crumbled to form discrete plural particles of animal litter. In other embodiments, a pelletized copra residue may be combined with other materials, such as by coating crumbled copra pellets with another absorbent material.

Further details concerning the preferred embodiments of the invention are set forth hereinbelow and in the appended claims.

### DETAILED DESCRIPTION OF PREFERRED EMBODIMENTS

Arecaceae (also known as Palmae), the palm family, is a family of flowering plants that is sometimes classified in the monocot order Arecales. There are over two hundred currently known genera in the family, collectively including around 2,600 species.

Economically important genera include Areca, Arenga, Attalea, Bactris, Borassus (Palmyra palm), Calamus (Rattan palm), Cocos (Coconut), Copernicia (Carnauba wax palm), Elaeis (Oil palm), Euterpe (Cabbage Heart palm), Jessenia, Jubaea (Chilean Wine palm and Coquito palm), Orbignya, Phoenix (Date palm), Raphia (Raffia palm), Rhapis, Roystonea (Royal palm), Sabal-Palmettos, Salacca, Salak Trachycarpus, Veitchia, Wallichia, and Washingtonia.

Coconut palm (Cocos Nucifer), one of the species in the cocos genre, is an especially important species in the Arecaceae family. The coconut palm yields coconut, which are large, simple dried fibrous drupes. Coconuts are typically ovoid in shape and generally range in gross size up to about 15 inches long and 12 inches wide. The exocarp of the coconut is green, yellow, or bronze-gold, and typically turns to a brown color, depending on cultivar and maturity. The mesocarp of the coconut becomes fibrous and dried at maturity, yielding a fiber known as coir. The hard shell endocarp encloses the seed of the coconut which is composed of both meat and liquid. The coconut meat when shredded and dried, yields a material known as copra, from which coconut oil may be extracted. Commercially, the meat also can be grated, mixed with water, and pressed to obtain coconut milk.

In large scale commercial processing, coconuts are processed to obtain copra, coconut oil, fibers, and other coconut residues. From these, various significant commercial products are produced, these including copra, coconut oil, copra cake, desiccated coconut, coconut fiber, coir and coir products, coir dust and coir dust products, shell products, and many coconut-based food products. Derivative products such as matting, brushes, brooms, and so forth are commercially prepared from some of the foregoing residues.

As discussed in more detail in Ranasinghe, T. K. G., Coconut Processing (1999), industrial processing of coconuts typically occurs by dehusking coconuts, cracking the coconuts with a steel rod or knife, shelling the coconuts to obtain a ball-shaped kernel, and paring the brown skin (“testa”). After paring, a white ball of coconut meat is yielded. The ball is pierced to release the liquid component, and, when making copra, the meat from the coconut is dried to produce dry copra having a moisture content of about 6%. The copra may be dried via one of many methods. In many cases, copra is dried via simple sun-drying. Copra also can be dried by using a dryer or kiln, with direct application of heat or smoke. In such cases, the kernels are typically placed on the platform 1.5 to 2.0 meters above a fueled fire for about three days. Copra also may be dried using indirect heat dryers, or hot-air dryers, where the copra is dried using heated air which moves through a bed of copra using a natural or forced draft.

Dried copra is then prepared for oil extraction by cutting it to size, possibly subjecting the copra to a subsequent drying step, heating it to the right temperature, maintaining at temperature for a period of time, and forming the dried copra into the right shape for extraction. Equipment such as hammer mills, peg mills, disc mills, rollers, and flakers, often are used in the oil extraction process. The mills are employed to break the copra into smaller size pieces and to open the oil cells to expose the oil for extraction. Rollers are employed to break and compress large articles left after crushing and grinding. Flakers are employed to compress the material into thin, firm flake suitable for solvent extraction.

The copra thus prepared typically contains about 52-72% coconut oil. Coconut oil is then extracted, typically via mechanically compressing the heated, dried copra or via solvent extraction of same. Commonly employed methods of oil extraction include the whole full-press method, the prepress solvent method, and the full-solvent extraction method. In the whole full-press method, pressure is applied to the material to expel oil, using a screw press or expeller. After full press extraction, the oil content in the residual copra cake is 6% to 10%. In a prepress solvent method, oil is partially extracted by preliminary low pressure mechanical extraction, followed by solvent extraction to remove most of the residual oil. The oil content of the copra material is reduced to about 16%-20% through mechanical extraction and to below 6% in the final copra cake.

In full-solvent extraction, oil in the dried, pre-heated ground copra is dissolved in a solvent, which typically is hexane. The solvent is removed by heating and boiling off of the volatile solvent, which typically is recovered by condensation. Traces of solvent left in the copra cake and most residual oil are removed by steam-stripping under reduced pressure.

Copra cake or meal derived from the expeller or solvent extraction processes may be ground to form fine particles by milling, such as via a hammer mill or a disc mill. The ground cake or meal may be bagged as-is or may be pelletized for shipping. If the cake or meal is pelletized, typically it is moistened to a moisture content of about 12% and then introduced to a pellet mill for pelletizing. Pellets formed from copra cake derived from a solvent process may be referred as copra extraction pellets. Such pellets typically contain less than 2% residual oil.

Other coconut products include brown or white coir, coconut fiber dust, and coco peat, as well as coconut shell flour. Coconut white coir fiber is the golden fiber obtained by retting fresh green husks in saline water for several months. Brown coir is fiber that is mechanically extracted from brown husks either by wet or dry milling. Coir fiber dust is produced when brown coir is extracted. This material often is compressed into briquettes or blocks. Coconut shell flour can be obtained by breaking shells into fragments of 5 to 6 mm with a hammer mill and then reducing these granules to a flour, typically less than 100 mesh. The shell flour then may be created into various sizes using a cyclone separator.

In accordance with certain embodiments of the invention, a copra residue is used in connection with an animal litter. “Copra residue” contemplates copra from a coconut of any species from which at least a portion of the oil originally present in the copra has been removed. In many embodiments, the oil content of the copra residue will be 6% or less. In some embodiments, a copra cake is employed. The copra residue may be used as-is as an animal litter, or alternatively may be blended with one or more additional animal litter ingredients as described herein. In some embodiments of the invention, copra cake residue is provided in the form of copra pellets, by which is contemplated pellets produced in a conventional commercial pellet mill. The pellets may be provided in any size useful in connection with an animal litter.

The animal litters of the invention may be formulated as clumping litters or as non-clumping litters. When formulated as non-clumping litter, the litter preferably is formulated to take the form of pellets, or cubes, or tablets, or pellets, or other compacted forms, particularly when the litter is intended as a cat litter. The litters in such cases preferably are formulated such that the compacted forms break down when wetted into smaller particles or powders. When so formulated, a litter box that contains soiled and unsoiled litter may be shaken by hand, and soiled powdery litter will drop to the bottom of the box, leaving unsoiled litter at the top of the litter box. Tracking of litter out of the box by the cat is thus minimized.

The copra residue may be present in any amount in the animal litter. The animal litter may consist of the copra residue, or may consist essentially of the copra residue, and thus the copra residue may be present in an amount of 100% by weight. In other embodiments, the copra residue is present in a lesser amount, such as 95%, 90%, 85%, 80%, 75%, 70%, 65%, 60%, 55%, 50%, 45%, 40%, 35%, 30%, 25%, 20%, 15%, or 10% by weight. In some embodiments, copra residue is present as the major absorbent component of the litter.

The copra residue optionally may be used in conjunction with one or more additional absorbent materials, such as a clay or other mineral. Any suitable clay or mineral may be used in conjunction with the invention. Suitable clays and minerals include sepiolite, bentonite, hectorite, beidelite, nontronite, saponite and other materials known to those skilled in the art, such as zeolite, montmorillonite, diatomaceous earth, opaline silica, crystalline silica, silica gel, Georgia White clay, sepiolite, calcite, dolomite, slate, pumice, tobermite, marls, attapulgite, kaolinite, halloysite, smectite, vermiculite, hectorite, Fuller's earth, fossilized plant materials, expanded perlite, and gypsum. Mixtures thereof may be employed in any desired ratio relative to one another. When clays are used, preferred clays are those that comprise principally alkali metal or alkaline earth bentonites, such as sodium bentonite, calcium bentonite, and sodium/calcium bentonite blends. The clay particles may have any suitable particle size, such as a size ranging from 0.05 to 10,000 microns.

The clay or clays may be used in any amount in the litter that is desired, and, if more than one type of clay is used, the clays may be used in any ratio with respect to one another. For instance, clay may be present in a total amount of 0%, 5%, 10%, 15%, 20%, 25%, 30%, 35%, 40%, 45%, 50%, 55%, 60%, 65%, 70%, 75%, 80%, 85%, 90%, or 95% by total dry weight of the litter. In some embodiments in the invention, the clay is used as a coating, as hereafter described.

In some embodiments, when copra residue is used in connection with a clay-based litter material, the copra residue is present in an amount ranging from 50%-90% by total dry weight of the litter, in some cases, from 55%-95% by total dry weight of the litter, with the balance comprising clay and a binder. When copra residue is used in connection with the litter that does not include clay, the copra residue may be present in the same amount, if desired. Typically however, the copra residue in such litters may be present in an amount ranging from 5%-95%, in some cases 50%-85%, and in some cases 20%-80%, by total dry weight of the litter. The remaining components of the litter preferably comprise one or more of the materials described herein, which materials may be present in any amounts by total weight and proportional weight to each other.

As stated hereinabove, the invention may provide a clumping animal litter that agglomerates when wetted by a liquid. Liquid may be introduced by animal urine excretions or liquid that is present in solid or semisolid animal excretions. In accordance with the invention, the litter may be provided in the form of discrete plural particles of litter, at least a portion of which particles will agglomerate into at least one clump when wetted. By “agglomerate” is meant formation of a relatively cohesive interparticle consolidation of at least two particles. By “clump” is meant a relatively cohesive consolidated mass, or agglomeration, of two or more particles. It is contemplated that the clumps of animal litter formed in accordance with the invention will comprise an agglomeration of at least two particles, and preferably a greater number of particles, the exact number depending upon the volume of liquid applied and the size of the particles.

It has been found that the particle size of ground copra meal can affect the clumping properties of an animal litter. Generally, when a clumping litter is desired the particle size should be sufficiently small such that the particles have a large surface area suitable for absorbing large quantities of animal waste. The exact particle size is a matter within the purview of those skilled in the art, and to some extent the particle size depends on the other components of the animal litter. Generally, a copra residue having a particle size distribution such that at least 50% of the particles pass through a 40 mesh screen is suitable. A ground coconut copra powder having the following profile is believed to provide a suitable clumping litter in many cases:

| % | | | | | % through |
|---|---|---|---|---|---|
| over 20 | % over 40 | % over 80 | % over 120 | % over 200 | 200 |
| Mesh | Mesh | Mesh | Mesh | Mesh | Mesh |
| 6 | 30 | 36 | 20 | 6 | 2 |

The copra may have any other suitable particle size profile.

If desired, a binder may be employed in the litter. The binder may be used to effectuate either or both intra-particle cohesion or inter-particle cohesion, in the latter case the inter-particle cohesion, being caused upon wetting of the litter. The binder may be disposed primarily or completely on the surface of the particles of litter, in which case the binder may operate as a clumping agent that will cause the litter to clump upon being wetted with animal urine. If the binder is included in the litter formulation and is not merely disposed on the surface, the binder may act as a cohesiveness agent, i.e., an agent that serves to keep the individual particles of litter together. Such a cohesiveness agent may also contribute to any clumping of the litter. Multiple binders may be employed; in some embodiments, both a cohesiveness agent and a separate clumping agent may be employed.

When used, the binder may comprise any suitable binder. For instance, lignin sulfonate, polymeric binders, fibrillated polytetrafluoroethylene, carboxymethyl cellulose and its derivatives and its metal salts, guar gum, cellulose, xanthan gum, starch, lignin, polyvinyl alcohol, polyacrylic acid, styrene butadiene resins, polystyrene acrylic acid resins, or crosslinked polyester networks may be employed, as well as mixtures of the foregoing materials. The binder may be used in any amount with respect to the other materials and in any overall amount suitable for use in binding particles of clay and copra residue. If used as a coating to effectuate clumping, the binder may be present in any suitable amount, and is preferably used in an amount ranging from 0.05% to 10%, more preferably, 0.1% to 5%, by total weight of the litter. If not used as a coating, the binder may be present in any suitable amount, typically an amount of 0.1-40% by weight.

When employed as a cohesiveness agent, the binder may be a polysaccharide, such as a starch. Other polysaccharide cohesiveness agents include flours, such as wheat, potato, tapioca or rye flours. A polysaccharide cohesiveness agent is believed to enhance bonding between grain proteins within the litter by creating hydrogen bonds between proteins and starch and associatively to other proteins. Such a polysaccharide cohesiveness agent may be present in any amount suitable to enhance the cohesiveness of the granules of animal litter. Preferably, when used, the cohesiveness agent is present in an amount of 1-25% by total dry weight.

When a polysaccharide cohesiveness agent is employed, the litter may further include a supplemental cohesiveness agent. The supplemental cohesiveness agent is an ionic species that is believed to enhance protein-protein and/or protein-starch interactions. Any suitable ionic salt may be used in conjunction with the invention. For example, in accordance with preferred embodiments of the invention, the supplemental cohesiveness agent when used is selected from among the alkali and alkaline-earth salts of common anions, such as the halide, nitrate, nitrite, carbonate, phosphate, sulfate, and bicarbonate salts, and the like. More preferably, the supplemental cohesiveness agent is selected from the group consisting of sodium chloride, calcium chloride, sodium carbonate, calcium carbonate, sodium bicarbonate and mixtures thereof. Even more preferably, the supplemental cohesiveness agent is selected from among sodium chloride, calcium carbonate, and mixtures thereof. Most preferably, the supplemental cohesiveness agent is sodium chloride. The supplemental cohesiveness agent may be present in any amount sufficient to assist the cohesiveness agent in enhancing the cohesion of the animal litter, preferably 1-5% by total dry weight of the litter.

If desired, organic or inorganic absorbents may be used in connection with the invention. The organic absorbents may include, for instance, whole ground grain, seed meal, wood chips, grain germ, spent grain germ, or the like. To some extent, these materials may be deemed functional fillers, in that they can be less expensive than copra residue. Generally, any suitable filler may be employed in conjunction with the invention.

If whole ground grain is used in connection with the invention, any suitable grain may be used. Exemplary whole ground grains include corn, wheat, rice, rye, sorghum, and other whole ground grains. The whole ground grain may be used in any amount desired in connection with the invention. If used, the whole ground grain may be used in any desired amount, for instance, 5%, 10%, 10%, 15%, 20%, 25%, 30%, 35%, 40%, 45%, 50%, 55%, 60%, 65%, 70%, 75%, 80%, 85%, 90%, or 95% by total dry weight of the litter.

In some embodiments, the filler is employed to reduce the cost of the ingredients and also to reduce the odor of the copra component of the litter. Exemplary odor-mitigating fillers include, for instance, corn cob and malt sprouts. Additionally, wood chips or sawdust may be used in connection with the invention. The most suitable woods include absorbent woods such as poplar, pine, birch, aspen, and cedar. If used, the wood chips or dust or other fillers may be used in any suitable amount, such as an amount of 5%, 10%, 15%, 20%, 25%, 30%, 35%, 40%, 45%, 50%, 55%, 60%, 65%, 70%, 75%, 80%, 85%, 90%, or 95% by total dry weight of the litter.

The litter of the invention may include a seed meal. Examples of such meals include linseed meal, soy bean meal, sunflower meal, cotton seed meal, rapeseed meal, peanut meal, safflower seed meal, and combinations thereof. By “seed” is meant to include that part of a plant which is capable of forming a new plant upon germination, e.g., whole grains of wheat, including the fruit or fruit-like structure housing the seed, but excluding copra. The seed meal comprises spent ground seed, which is seed residue from which oil has been expelled, such as by solvent extraction or expeller extraction. The extracted residue then is ground, by which is contemplated the reduction of the residue to smaller particles, preferably to a semi-course to fine powder. It is contemplated that some seeds will include a hull that may (but need not) be removed prior to expelling oil and grinding. Thus, the meal may comprise a dehulled meal or a meal that includes hulls. If used, the seed meal may be used in any suitable amount, such as an amount of 5%, 10%, 15%, 20%, 25%, 30%, 35%, 40%, 45%, 50%, 55%, 60%, 65%, 70%, 75%, 80%, 85%, 90%, or 95% by total dry weight of the litter.

Alternatively, or in addition, thereto, the litter may include a grain germ derived from any suitable grain. While grains such as wheat, corn, soy, sorghum, alfalfa, and barley are suitable for use in conjunction with the invention, the grain-based substrate, when used, preferably is a corn-based substrate. Most preferably, when used, the grain-based substrate is a grain germ, and even more preferably the substrate is corn germ that is obtained in a wet or dry milling process. The grain germ preferably comprises spent germ, which is grain germ from which oil has been expelled, such as by pressing or hexane or other solvent extraction. Most preferably, the grain germ is expeller extracted, that is, the oil has been removed by pressing. If used, germ may be used in any suitable amount, such as an amount of 5%, 10%, 15%, 20%, 25%, 30%, 35%, 40%, 45%, 50%, 55%, 60%, 65%, 70%, 75%, 80%, 85%, 90%, or 95% by total dry weight of the litter.

It has been found that washing of grain germ and seed meal, prior to the incorporation of these ingredients in an animal litter will substantially remove odor components from the substrate. By so removing the odor components, washing will render the litter more acceptable to cat owners and substantially edibly unattractive to animals such as dogs. It is further believed that washing will reduce the level of flavor components in the grain-based substrate. For these reasons, when a seed meal or grain germ is employed, preferably these materials are washed prior to incorporation into the litter. Any suitable washing step can be employed in conjunction with the invention. For example, the washing may be countercurrent washing. Any suitable washing solvent, such as an aqueous solvent, may be employed in conjunction with the invention. The washing solvent may be selected from among methanol, ethanol, hydrogen peroxide, water, and mixtures thereof; most preferably, the washing solvent is water.

In accordance with some embodiments of the invention, the particles are in the form of compressed or compacted particles, i.e., in the form of granules. By “granules” is meant particles that are compressed or compacted, such as by a pelletizing, extrusion, or similar compacting step. Such compression or compacting of the particles is preferred, inasmuch as the intraparticle cohesion of the particles will be enhanced by such compacting or compressing step. The granules may be prepared by pelletizing the substrate in a commercial pellet mill. If desired, the pellets prepared thereby may be ground or crumbled to a granule size suitable for use as an animal litter. In some embodiments, the animal litter is in the form of granules having a granule size ranging from about 4 to about 400 mesh (USS); in other embodiments, about 8 to about 80 mesh; and in other embodiments about 14 to about 20 mesh. A lubricity agent, such as corn oil, optionally may be used in the pellet mill. In other embodiments of the invention, the litter is prepared by other compacting or compressing processes such as, for example, by extrusion of the substrate through a die and grinding of the extrudate to a suitable granule size.

In some embodiments of the invention, the animal litter particle, or pellet, is coated with a clumping agent and/or a performance enhancing filler or binder. For instance, the clumping agent may include bentonite, zeolite, montmorillonite, diatomaceous earth, opaline silica, crystalline silica, silica gel, Georgia White clay, sepiolite, calcite, dolomite, slate, pumice, tobermite, marls, attapulgite, kaolinite, halloysite, smectite, vermiculite, hectorite, Fuller's earth, fossilized plant materials, expanded perlite, gypsum, and mixtures thereof. The filler or binder may include, for instance, lignin sulfonate, polymeric binders, fibrillated polytetrafluoroethylene, carboxymethyl cellulose and its derivatives and its metal salts, guar gum, cellulose, xanthan gum, starch, lignin, polyvinyl alcohol, polyacrylic acid, styrene butadiene resins, polystyrene acrylic acid resins, cross linked polyester networks, and combinations thereof. When a coated particle is so prepared, the particle size preferably is in the range from 1 mm to 10 mm. It is believed that a particle size in this range will lead to diminished tracking of the litter.

The litter further may include a preservative, such as a mold inhibitor. Suitable preservatives include, for instance, citric acid, potassium sorbate, and the propionate salts, most preferably sodium propionate and calcium propionate. When used, the preservative may be present in any amount sufficient to provide a preservative effect for the animal litter, preferably, an amount ranging from about 0.02% to about 3.5% by total dry weight.

The litter may further include an olfactory agent, by which is completed a material whose functional purpose is to deodorize and/or to provide fragrance. Natural herbs and spices may be employed as olfactory agents. When used, the olfactory agent may be present in any suitable amount. In some embodiments, the olfactory agent is present in an amount ranging from 0.1%-10% by weight. In some embodiments the olfactory agent is present in an amount ranging from 1-5% by weight.

The litter may have any moisture content that permits use as an animal litter. When the litter is in the form of a clumpable product, the litter preferably has a moisture content sufficiently high to prevent the granules of animal litter from becoming friable and sufficiently low to allow additional moisture to be absorbed. Preferably, the moisture content is less than about 30%. More preferably, the moisture content ranges from about 5% to about 25%; even more preferably, the moisture content ranges from about 10% to about 20%; even more preferably, the moisture content ranges from about 12% to about 16%. It is contemplated that some of the moisture in the animal litter will be present originally in the grain-based substrate and/or cohesiveness agent.

An animal litter prepared in accordance with the present teachings will be effective in suppressing odors of animal waste. Animal urine contains urea, a compound which breaks down in animal litterboxes to form ammonia. The ammonia odor of animal litterboxes is often considered to be objectionable. Animal litters made in accordance with the preferred embodiments of the invention will be effective in masking ammonia odors. A litterbox containing such litter will remain free from ammonia odors even after a substantial period of time after an animal has excreted waste into the litter.

After soiled litter has dropped to the bottom of the litter box, some or all of the soiled litter may be removed from the box, for instance, by separating the soiled litter from remaining unsoiled litter and disposing of the soiled litter. Alternatively, the soiled litter may be removed without separating it from any unsoiled litter in the box, by disposing of all or substantially all of the litter in the box. In either case, animal waste will be thereby removed. Optionally, the supply of litter may be replenished with fresh litter. If the litter is not used in a container (for instance, the litter is spread onto a field), the soiled litter may be removed from the area in which the litter originally was applied.

When the litter is formulated as a clumping litter, soiled litter may be removed by removing soiled clumps of litter. In either case, whether the litter is a clumping litter or is not a clumping litter, the removal of soiled litter preferably also contemplates the removal of solid waste.

The litter of the invention preferably has a density ranging from about 15 to about 45 lbs./cu.ft. More preferably, the density of the litter of the invention ranges from about 25 to about 40 lbs./cu.ft.; and even more preferably, the density is in the range of from about 30 to about 38 lbs./cu.ft. Density preferably is evaluated after loosely filling a container and measuring the weight of a specific volume of the litter.

Because the animal litter of the invention is to be used to absorb animal waste, the litter should have a sorption capacity sufficient to allow the animal litter to so function. The sorption capacity of the preferred litters of the invention typically is at least about 0.04 ml water per gram of litter, and more typically ranges from about 0.04 to about 2.4 ml/g; more typically, the sorption capacity is from about 0.5 to about 1.4 ml/g. The sorption capacity is determined per gram of animal litter, and is based on the sorption of deionized water, as described in more detail in U.S. Pat. No. 6,098,569. Preferred sorption capacity ranges of water are believed to approximate that of animal urine.

Other properties may be desired of an animal litter. When used as a cat litter, a sand-like texture is preferred. To minimize inconvenience and mess associated with packaging, transporting, and using the litter, the litter preferably generates a minimal amount of dust.

The preferred litters of the present invention do not generate substantial dust. Another preferred property of the litters, when the litters are provided in a clumping formulation, is clumping efficiency. Clumping efficiency is the amount of litter required to form a clump with a given volume of liquid, with lower amounts of required litter corresponding to higher clumping efficiencies. Preferably, to absorb 150 ml animal urine, less than about 200 g of litter is required; more preferably, less than about 150 g is required. The weight of the clumps thus formed preferably is in the range of 50-70 g, the weight being determined in accordance with the procedures specified in the examples of U.S. Pat. No. 6,098,569.

Other desired properties include biodegradability and, when the litter takes the form of a clumping litter, tendency to remain clumped. Biodegradability is particularly desired when the animal owner wishes to dispose of clumps of litter by flushing them into the toilet. The litter of the invention is believed to be at least as biodegradable as hull-based materials, and thus the litter of the invention may be disposed of by flushing, even into a septic system. Litters made with clay ordinarily should not be flushed into a septic system, but may be flushable into a municipal sewer system. Tendency to remain clumped refers to the stability of the clump of clumped cat litter. A clumping litter should remain clumped for at least 48 hours after the clump has formed. The litters of at least many embodiments of the invention have an excellent tendency to remain clumped.

The invention is also directed towards a process for preparing an animal litter. In accordance with the invention, the process comprises the step of providing the ingredients as previously described, and combining them to form a litter. Preferably, the process includes a step of compacting or compressing the particles of animal litter into granules, or nuggets, or cubes, or tablets, or pellets, generally with heat and/or pressure. Preferably, the compaction is accomplished in a pelletizing step. The preservative and cohesiveness agent, when used, can be added at any suitable time, and preferably are mixed with the seed meal in the desired proportions prior to pelletizing.

Any suitable conditions may be employed in the pellet mill used in the pelletizing operation. Moisture content in the pellet mill feed preferably is in the ranges set forth above with respect to the moisture content in the finished product, and preferably is about 8-12% and in some cases, 14-14.5%. Preferably, moisture is added to the feedstock in the form of liquid water to bring the feedstock to this moisture content. The temperature in the pellet mill preferably is brought to a suitable temperature, preferably ranging from about 38° C. to about 148° C., in some instances a temperature of about 82° C., with steam. The pellet mill may be operated under any conditions that impart sufficient work to the feedstock to provide pellets. In one embodiment, the pellet mill is operated with a ⅛ in.×½ in. (diameter×length) die at 100 lb./min. pressure at 82° C. to provide pellets, which then are crumbled in a pellet mill crumbler to provide discrete plural particles having a particle size capable of passing through an 8 mesh screen but being retained on a 20 mesh screen. The die size may be different; it is contemplated that sizes ranging from 3/32 in. to ⅝ in. and any suitable thickness may be employed. Further details concerning pelletizing can be set forth as forth in U.S. Pat. Nos. 6,868,802; 6,622,658; 6,405,677; 6,216,634; and 6,098,569.

Also encompassed by the invention is a method for the removal of animal waste. In accordance with the invention, the method comprises the steps of providing a quantity of an animal litter, and allowing an animal to excrete waste into the litter. If desired, soiled litter may be separated from the remaining quantity of unsoiled litter. In either case, some or all of the soiled litter is then removed to thereby remove animal waste. The litter may be provided in a container, which may be filled with the litter to a suitable depth, such as 1 inch, 2 inches, 3 inches, or 4 inches, preferably 3-4 inches. By “container” is meant any enclosed or partially enclosed area, such as a litterbox, a cage, a stall, a pen (such as a poultry cage), or the like. The method is contemplated to be useful for any animals, such as cats, dogs, mice, birds (especially poultry birds such as turkeys and chickens), cattle, horses, gerbils, and other animals, and finds particular applicability in connection with removal of waste from house cats and of poultry waste.

The following examples demonstrate various embodiments of the invention, but should not be construed as limiting the invention in scope.

### Example 1

A conventionally prepared copra cake is employed as an animal litter. The copra cake is placed into a cat litter box for use by a household cat.

### Example 2

Copra cake pellets are employed as an animal litter. The dried copra is extracted with a hexane solvent. The solid residual product, copra cake, is further dried and pelletized in a pellet mill. The pellet mill is operated at a temperature between 200-250 degrees F. The die of the pellet mill has holes having a diameter ranging between 10 mm and 30 mm thickness. The resulting pellets are crumbled and used as an animal litter.

### Example 3

An animal litter is prepared in accordance with the following formulation:

| Ingredient | Weight Percent |
|---|---|
| Copra cake | 23% |
| Corn starch | 12% |
| Ground whole corn | 31.85% |
| Defatted corn germ meal | 26.25% |
| Ground corn germ | 3.75% |
| Citric acid | 1% |
| Salt | 2% |
| Potassium Sorbate | 0.15% |

Pellets are formed from the foregoing ingredients.

### Example 4

An animal litter is formulated in accordance with the following formulation:

| Ingredient | Weight Percent |
|---|---|
| Copra cake | 70% |
| Bentonite clay | 29.5% |
| Guar gum | 0.5% |

This material is pelletized and crumbled to form an animal litter.

### Example 5

An animal litter is prepared in accordance with the following formulation. A ground copra cake is used as the copra residue. The copra cake is first ground into a fine flour.

| Ingredient | Weight Percent |
|---|---|
| Copra residue | 71.85% |
| Corn starch* | 23% |
| Palm oil | 2% |
| Salt | 2% |
| Citric acid | 1% |
| Potassium Sorbate | 0.15% |

*Starch B20F, available from Grain Processing Corporation of Muscatine, Iowa.

The foregoing ingredients are combined in a pellet mill to form pellets, which are crumbled to a size suitable for use as an animal litter.

### Example 6

The copra residue in this Example is a fine copra flour.

| Ingredient | Weight Percent |
|---|---|
| Copra residue | 60% |
| Corn starch | 36.85% |
| Salt | 2% |
| Citric acid | 1% |
| Potassium Sorbate | 0.15% |

These ingredients are formed into pellets in a commercial pellet mill, and are ground to a size to be used as an animal litter.

### Example 7

Example 7 is repeated, except that corn flour is used in lieu of corn starch.

### Example 8

Example 7 is repeated, except that rice flour is used in lieu of corn starch.

### Example 9

Example 7 is repeated, except that wheat flour is used in lieu of corn starch.

### Example 10

Example 7 is repeated, except that wheat midds are used in lieu of corn starch.

### Example 11

In this Example, a copra residue is used in connection with a WATER LOCK® product, a super-absorbent polymer, made by Grain Processing Corporation of Muscatine, Iowa.

| Ingredient | Weight Percent |
|---|---|
| Copra cake | 76.85% |
| Pre-gelatinized starch | 10% |
| WATER LOCK ®: | 10% |
| Salt | 2% |
| Citric acid | 1% |
| Potassium Sorbate | 0.15% |

The foregoing materials are combined in a pellet mill to form pellets, which are crumbled to form discrete plural particles of a size suitable for use as an animal litter.

### Example 12

Copra pellets are coated with a clumping agent that comprises bentonite. The pellets have a size in the range of 1 mm to 10 mm. These coated copra pellets are used in an animal litter.

### Example 13

Coconut copra cake was ground through a Fitz mill and an Alpine mill to yield a fine powder. This powder was then blended with corn starch and other materials. The resultant blend was pelletized using a California Pellet Mill with a with 5/32″ diameter×½″ depth die. Steam was injected into pre-conditioner of the pellet mill to heat the blend to 140° F.-165° F. in temperature and increase moisture content. The pellets thus formed were crumbled to form discrete plural particles. The resultant litter was found to have a clump weight of 65.6 grams.

| Ingredient | Weight Percent |
|---|---|
| Finely ground coconut copra meal (1 pass | 60.85% |
| through Fitz, 1 pass Alpine) | |
| Corn starch | 34.00% |
| Vegetable oil | 2.00% |
| Salt | 2.00% |
| Citric acid | 1.00% |
| Potassium Sorbate | 0.15% |

### Example 14

A litter was prepared using copra residue ground as per Example 13 in combination with corn cob and other materials. The litter was composed of the following ingredients, which were pelletized using a California Pellet Mill with a with 5/32″ diameter×½″ depth die. Steam was injected into pre-conditioner of the pellet mill to heat the blend to 140° F.-165° F. in temperature and increase moisture content. The pellets formed were crumbled into discrete plural particles. The litter thus formed had a clump weight of 62.1 grams

| Ingredient | Weight Percent |
|---|---|
| Finely ground coconut copra meal 1 pass | 40.85% |
| through Fitz, 1 pass Alpine) | |
| Fine ground corn cob (Mill: 1 pass Fitz + 1 | 20.00% |
| pass Alpine) | |
| Corn starch | 34.00% |
| Vegetable oil | 2.00% |
| Salt | 2.00% |
| Citric acid | 1.00% |
| Potassium Sorbate | 0.15% |

### Example 15

An animal litter is prepared in the same manner as Example 14, except that malt sprouts are used instead of corn cob.

| Ingredient | Weight Percent |
|---|---|
| Ground coconut copra meal | 30.00% |
| Fine ground malt sprouts | 33.00% |
| Corn starch | 30.90% |
| Virgin corn germ | 3.00% |
| Salt | 2.00% |
| Citric acid | 1.00% |
| Potassium Sorbate | 0.10% |

### Example 16

Coconut copra cake was ground through a hammer mill with a 1/16″ opening screen to a fine powder and then blended with tapioca flour and other materials. The blend was pelletized using a 100 hp California Pellet Mill with a with 3/16″ diameter×2″ depth (4.7625 mm×50.8 mm) die. Steam was injected into pre-conditioner of the pellet mill to heat the blend to 140° F.-165° F. in temperature and increase moisture content. The pellets formed were crumbled into discrete plural particles. Upon wetting, the particles formed solid clumps with a weight of 60 grams

| Ingredient | Weight Percent |
|---|---|
| Fine ground defatted copra cake | 61.85% |
| (Hammer mill- 1/16″ opening screen) | |
| Tapioca flour | 30.00% |
| Vegetable oil | 5.00% |
| Salt | 2.00% |
| Citric acid | 1.00% |
| Potassium Sorbate | 0.15% |

### Example 17

In the same manner as Example 16, a litter was prepared from the following ingredients.

| Ingredient | Weight Percent |
|---|---|
| Fine ground defatted copra cake | 54.85% |
| (Hammer mill- 1/16″ opening screen) | |
| Tapioca flour | 37.00% |
| Vegetable oil | 5.00% |
| Salt | 2.00% |
| Citric acid | 1.00% |
| Potassium Sorbate | 0.15% |

The litter had a clump weight of 58.5 g and a sand-like texture.

### Example 18

An animal litter having the following formulation is prepared. The coconut copra cake is ground through a hammer mill with a 1/16″ opening screen to a fine powder and then blended with corn starch and other materials. The blend is pelletized using a 100 hp California Pellet Mill with a with 3/16″ diameter×2″ depth (4.7625 mm×50.8 mm) die.

Steam is injected into pre-conditioner of the pellet mill to heat the blend to 140° F.-165° F. and increase moisture content. The pellets formed are crumbled into discrete plural particles.

| Ingredient | Weight Percent |
|---|---|
| Fine ground defatted copra cake | 57% |
| (Hammer mill- 1/16″ opening screen) | |
| Unmodified corn starch (B200) | 32.00% |
| Corn germ | 7.85% |
| Salt | 2.00% |
| Citric acid | 1.00% |
| Potassium Sorbate | 0.15% |

### Example 19

In the same manner as Example 18, a copra-based animal litter is formed from the following ingredients.

| Ingredient | Weight Percent |
|---|---|
| Fine ground defatted copra cake | 57% |
| (Hammer mill- 1/16″ opening screen) | |
| Wheat midds | 35.00% |
| Vegetable oil | 5% |
| Salt | 2.00% |
| Citric acid | 1.00% |
| Potassium Sorbate | 0.15% |

It is thus seen that a satisfactory animal litter is prepared using a copra residue.

All references, including publications, patent applications, and patents, cited herein are hereby incorporated by reference. In any listing of possible ingredients or components, mixtures of the possible ingredients or components are contemplated unless expressly indicated otherwise. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention unless otherwise claimed. No language in the specification should be construed as indicating any non-claimed element as essential to the practice of the invention. This invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for removal of animal waste, comprising:
providing a quantity of an animal litter, said animal litter comprising a copra residue;
allowing animal to excrete waste onto said litter, whereby at least a portion of liquid from said waste is absorbed into said litter; and
removing at least a portion of soiled litter.

2. A method according to claim 1, said copra residue comprising copra cake.

3. A method according to claim 1, said copra residue comprising copra oil cake.

4. A method according to claim 1, said litter being in the form of discrete plural compacted particles.

5. A method according to claim 2, said litter being in the form of discrete plural compacted particles.

6. A method according to claim 3, said litter being in the form of discrete plural compacted particles.

7. A method according to claim 1, said litter including an additional liquid absorbent material selected from the group consisting of whole ground grain, spent germ, virgin germ, seed meal, and clay.

8. A method according to claim 7, said litter being in the form of discrete plural compacted particles.

9. A method according to claim 8, said particles tending to agglomerate when wetted to from a clump, the method including removing clumped soiled litter from said container.

10. A method according to claim 1, said litter being provided in a container.

11. A method according to claim 1, said soiled litter being removed thereby leaving remaining litter, at least a portion of the remaining litter being litter that has been soiled.

12. An animal litter comprising a copra residue at least one absorbent selected from the group consisting whole ground grain, spent germ, virgin germ, seed meal, and clay.

13. An animal litter according to claim 12, including spent germ.

14. An animal litter according to claim 12, said litter being in the form of discrete plural particles that tend to agglomerate when wetted to form a clump.

15. An animal litter according to claim 12, further comprising a cohesiveness agent.

16. An animal litter according to claim 15, said cohesiveness agent comprising a polysaccharide.

17. An animal litter according to claim 12, comprising copra cake.

18. An animal litter according to claim 12, comprising copra oil cake.

19. A process for preparing an animal litter comprising combining a copra residue and at least one other absorbent material selected from the group consisting of virgin germ, spent germ, whole ground grain, seed meal, and clay.

20. A process according to claim 19, said absorbent material comprising clay.

21. A process according to claim 20, further comprising adding a binder.

22. A process according to claim 19, said absorbent material being spent corn germ.

23. A process according to claim 19, the process comprising compacting said copra residue and said absorbent material to form discrete plural particles.

24. A process according to claim 23, said compacting being accomplished in a pellet mill.

25. A process according to claim 24, including reducing the size of pellets from said pellet mill via crumbling.
